(19) United States
(12) Patent Application Publication
(10) Pub. No.: US 2013/0130006 A1
(43) Pub. Date: May 23, 2013

(54) EXTERIOR FOR OBJECT AND OBJECT WITH EXTERIOR COATING

(71) Applicant: Fujitsu Limited, Kawasaki-shi (JP)

(72) Inventors: Ryosaku INAMURA, Hadano (JP); Kazuhiro KAKUGUCHI, Setagaya (JP)

(73) Assignee: FUJITSU LIMITED, Kawasaki-shi (JP)

(21) Appl. No.: 13/674,629

(22) Filed: Nov. 12, 2012

(30) Foreign Application Priority Data
Nov. 17, 2011 (JP) 2011-251682

(51) Int. Cl. B32B 7/02

(52) U.S. Cl. CPC B32B 7/02
USPC 428/217

(57) ABSTRACT

An exterior for an object includes: a base portion; an underlying layer disposed over the base portion; and a hard coat layer disposed over the underlying layer, the hard coat layer including a plurality of layers that have different hardnesses and are laminated each other.

### CROSS-REFERENCE TO RELATED APPLICATION(S)

This application is based upon and claims the benefit of priority of the prior Japanese Patent Application No. 2011-251682, filed on Nov. 17, 2011, the entire contents of which are incorporated herein by reference.

### FIELD

The embodiments discussed herein are related to an exterior for an object and an object with an exterior coating.

### BACKGROUND

The housings of portable devices, such as mobile phones, to be carried by users comprise flexible resin because of its lightweight or good moldability. The surface (outer surface) of an exterior for a portable device tends to be damaged because it comes into contact with and rubs against its surrounding objects while the device is carried in a bag or attached to a belt. The surface of the exterior for the portable device is therefore subjected to coating (hereinafter, referred to as an “exterior coating”) such that the surface is covered or coated with a material excellent in resistance to wear or abrasion.

Japanese Laid-open Patent Publication No. 6-270350 discusses a related art.

### SUMMARY

According to one aspect of the embodiments, an exterior for an object includes: a base portion; an underlying layer disposed over the base portion; and a hard coat layer disposed over the underlying layer, the hard coat layer including a plurality of layers that have different hardnesses and are laminated each other.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1A illustrates an exemplary appearance of an object;

FIG. 1B illustrates an exemplary exterior coating;

FIG. 2A illustrates an exemplary exterior coating;

FIG. 2B illustrates an exemplary sample;

FIG. 3 illustrates an exemplary sample;

FIG. 4 illustrates an exemplary exterior coating;

FIG. 5 illustrates an exemplary exterior coating;

FIG. 6 illustrates an exemplary exterior coating;

FIG. 7 illustrates an exemplary exterior coating;

FIG. 8 illustrates an exemplary sample; and

FIG. 9 illustrates an exemplary accessory.

### DESCRIPTION OF EMBODIMENTS

For example, the outer surface of a resin molded component comprising polycarbonate resin is coated with acrylic resin, thus forming an acrylic resin layer on the component. The acrylic resin layer is coated with ultraviolet-curable acrylic resin, thus forming a hard coat layer on the acrylic resin layer.

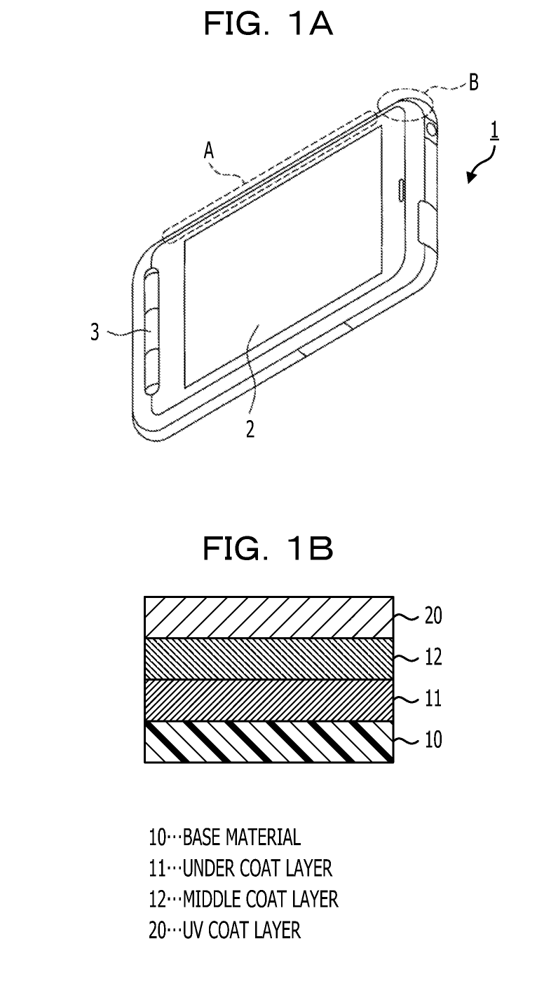

FIG. 1A illustrates an exemplary appearance of an object. FIG. 1A is a perspective view of the appearance of a mobile phone 1 as the object with an exterior coating. The mobile phone 1 may be a multifunction mobile phone (smartphone). The mobile phone 1 includes a display 2 having a touch panel function and operational buttons 3. Since the display 2 displays operational buttons for input upon operation and an input is performed by touching the operational buttons, the number of operational buttons 3 may be small.

FIG. 1B illustrates an exemplary exterior coating. FIG. 1B may be a fragmentary sectional view of the exterior coating for the mobile phone 1 in FIG. 1A. A housing of the mobile phone 1 includes synthetic resin. An undercoat layer 11 is formed as an underlying layer over a base material 10, serving as synthetic resin, and a middle coat layer 12 is formed as an underlying layer over the undercoat layer 11 An ultraviolet-curable hard coat layer 20 (hereinafter, referred to as the “UV coat layer 20”) is formed over the middle coat layer 12. The undercoat layer 11 and the middle coat layer 12 comprise urethane coating. The UV coat layer 20 comprises acrylic urethane UV-curable coating.

Since the mobile phone 1 is carried by the user while being put in, for example, a pocket or bag, the mobile phone 1 may come into contact with another object while being carried. The exterior coating may come off at or separate from, for example, an edge A or a corner B of the exterior for the mobile phone 1 in FIG. 1A, which is indicated by a broken line, because the edge A or the corner B has a small area applied with a contact pressure from another object and a contact pressure per unit area of the edge A or the corner B becomes large.

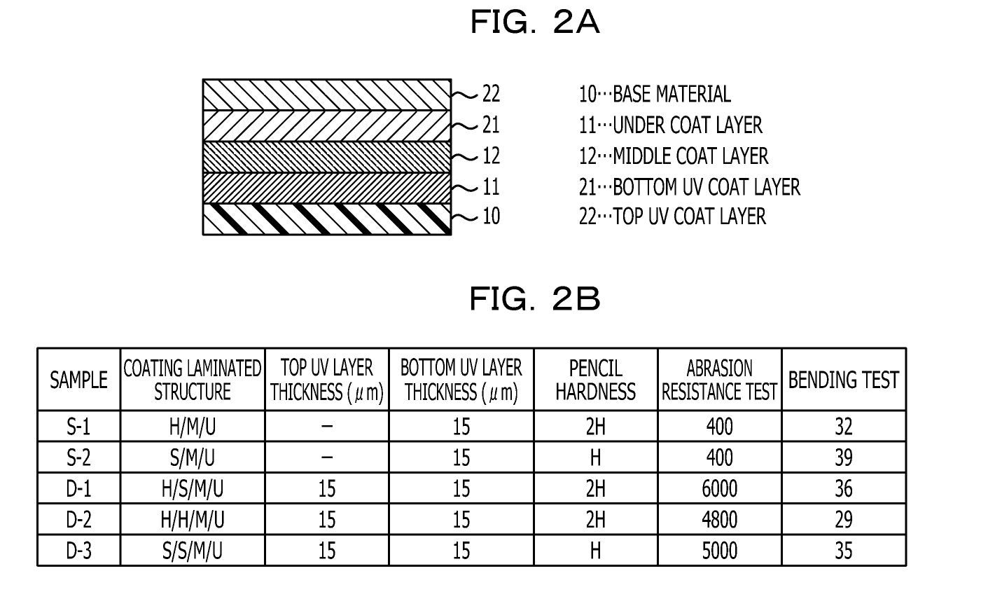

FIG. 2A illustrates an exemplary exterior coating. The exterior coating of FIG. 2A may reduce separation. For example, an object housing including synthetic resin serves as a base material 10. An undercoat layer 11 is formed as an undercoat layer over the base material 10 and a middle coat layer 12 is formed as an undercoat layer over the undercoat layer 11. A first UV coat layer (hereinafter, referred to as the “bottom UV coat layer”) 21 is formed as a hard coat layer over the middle coat layer 12 and a second UV coat layer (hereinafter, referred to as the “top UV coat layer”) 22 is formed as a hard coat layer over the bottom UV coat layer 21.

The bottom UV coat layer 21 has a lower hardness than the top UV coat layer 22. For example, in the case where the hardness of the bottom UV coat layer 21 is a pencil hardness of H, the hardness of the top UV coat layer 22 is set to a pencil hardness of 2H. The bottom UV coat layer 21 and the top UV coat layer 22 each may have a thickness of 15 μm.

As regards “pencil hardness”, a pencil (having a core hardness ranging from 6B to 6H) with a flattened core at its tip is held at 45 degrees relative to the surface of a coating by a hand and is then pushed forward by approximately 3 mm with a load of 1 kg at a velocity of approximately 3 mm/s. After graphite of the pencil is removed with a soft cloth or the like, the coating is observed to determine whether coat layers have a break or scratch that reaches a base material. When it is determined that there is a break or scratch, the hardness of the pencil is determined as any of grades 6B to 6H of “pencil hardness”. A pencil harness tester that moves a pencil under the above-described conditions determines “pencil hardness”.

FIG. 2B illustrates an exemplary sample. For example, in the case where the bottom UV coat layer 21 has a pencil hardness of H, the hardness of the top UV coat layer 22 is set to a pencil hardness of 2H. FIG. 2B illustrates the laminated structures, the thickness of the top UV layer and that of the bottom UV layer, the pencil hardness, and the results of an abrasion resistance test and a bending test for each five samples S-1, S-2, D-1, D-2, and D-3. Each of the top UV layers and the bottom UV layers may have a thickness of 15 μm. A UV coat layer having a pencil hardness of H is represented as a UV coat layer S and a UV coat layer having a pencil hardness of 2H is represented as a UV coat layer H.

In the abrasion resistance test, a drawing sand eraser having a hardness of approximately 70° was slid on or rubbed against each coating surface with a pressure of 2.94 N/cm² (approximately 300 g/cm²) and the number of rubbing times was counted until the base material was exposed on the coating surface. As the number of rubbing times was larger, the abrasion resistance test revealed a better result. In the bending test, one end of each test specimen was fixed, a load was hung on part positioned 70 mm away from the fixed end of the specimen to its free end, and the specimen was bent such that the free end was raised. A variation in the direction in which the free end was raised, in the part, which is positioned 70 mm away from the fixed end, was determined upon occurrence of a crack in the coating. As the variation was larger, the bending test revealed a better result. Each specimen may have a thickness of 1 mm, a width of 25 mm, or a length of 120 mm.

Referring to FIG. 2B, in the samples S-1 and S-2, a UV coat layer is a single layer. In the samples D-1, D-2, and D-3, a UV coat layer is two-layered. As regards the laminated structures of the coatings, H indicates a UV coat layer having a pencil hardness of 2H, S indicates a UV coat layer having a pencil hardness of H, M indicates a middle coat layer, and U indicates an undercoat layer. For example, H/M/U listed in the coating laminated structure section corresponding to the sample S-1 means that the undercoat layer U, the middle coat layer M, and the UV coat layer H having a pencil hardness of 2H are formed over the base material in this order. For example, H/S/M/U listed in the coating laminated structure section corresponding to the sample D-1 means that the undercoat layer U, the middle coat layer M, the UV coat layer S having a pencil hardness of H, and the UV coat layer H having a pencil hardness of 2H are formed over the base material in this order.

As illustrated in FIG. 2B, some UV coat layers may be two-layered. Like the sample D-2, when each of the two layers of the UV coat layer are set to be a UV coat layer H having a pencil hardness of 2H, the result of the pencil hardness test may be good. Like the sample D-3, when each of the two layers of the UV coat layer are set to be a UV coat layer S having a pencil hardness of H, the result of the bending test may be good. Like the sample D-1, when the undercoat layer U, the middle coat layer M, the UV coat layer S having a pencil hardness of H, and the UV coat layer H having a pencil hardness of 2H are formed over the base material, the pencil hardness test and the abrasion resistance test may reveal good results.

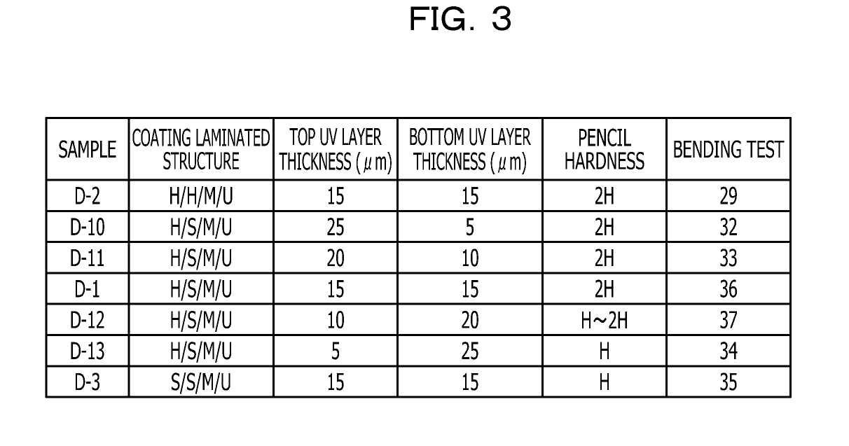

FIG. 3 illustrates an exemplary sample. FIG. 3 illustrates the laminated structures of coatings of the samples, the thicknesses of the top and bottom UV layers of each sample, the pencil hardness of each sample, and the result of a bending test on each sample that correspond to seven samples including top and bottom UV layers having difference thicknesses. The samples D-1, D-2, and D-3 may be substantially the same as those illustrated in FIG. 2B. Each of samples D-10, D-11, and D-12 may include a top UV coat layer H and a bottom UV coat layer S, the layers H and S having thicknesses different from the thickness of the layers H and S of the sample D-1 in FIG. 2B.

The thickness of the top UV coat layer H of the sample D-10 may set to be 25 μm by increasing that of the sample D-1. The thickness of the bottom UV coat layer S of the sample D-10 may set to be 5 μm by reducing that of the sample D-1. The bending strength of the sample D-10 may be less than that of the sample D-1. The thickness of the top UV coat layer H of the sample D-11 may set to be 20 μm by increasing hat of the sample D-1. The thickness of the bottom UV coat layer S of the sample D-11 may be set to be 10 μm by reducing that of the sample D-1. The bending strength of the sample D-11 may be less than that of the sample D-1. The thickness of the top UV coat layer H of the sample D-12 may be set to be 10 μm by reducing that of the sample D-1. The thickness of the bottom UV coat layer S of the sample D-12 may be set to be 20 μm by increasing that of the sample D-1. The pencil hardness of the sample D-12 may be less than or equal to that of the sample D-1. The thickness of the top UV coat layer H of the sample D-13 may be set to be 5 μm by reducing that of the sample D-1. The thickness of the bottom UV coat layer S of the sample D-13 may be set to be 25 μm by increasing that of the sample D-1. The pencil hardness of the sample D-13 may be less than that of the sample D-1.

As illustrated in FIG. 3, in the case where the top UV layer and the bottom UV layer have a thickness in the range of 10 to 20 μm, good results may be obtained. The thickness where the best result may be obtained may be in the range of 12 to 18 μm. After the undercoat layer U and the middle coat layer M are formed over the base material 10, the bottom UV coat layers 21 having a pencil hardness of H and a pencil hardness of 2H respectively, and the top and bottom UV coat layers are formed each having a thickness of 15 μm.

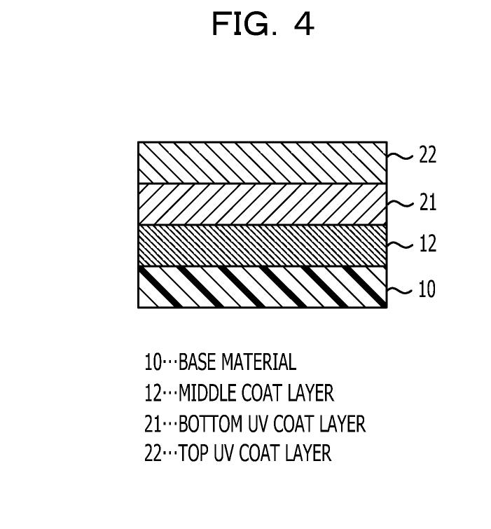

FIG. 4 illustrates an exemplary exterior coating. FIG. 4 is a fragmentary sectional view of the exterior coating. A middle coat layer 12 alone is formed over base material serving as an underlying layer. A bottom UV coat layer 21 is formed over the middle coat layer and a top UV coat layer 22 is formed over the bottom UV coat layer 21. The bottom UV coat layer 21 has a lower hardness than the top UV coat layer 22. For example, in the case where the hardness of the bottom UV coat layer 21 is a pencil hardness of H, the hardness of the top UV coat layer 22 is set to a pencil hardness of 2H. The bottom UV coat layer 21 and the top UV coat layer 22 may have a thickness of 15 pm.

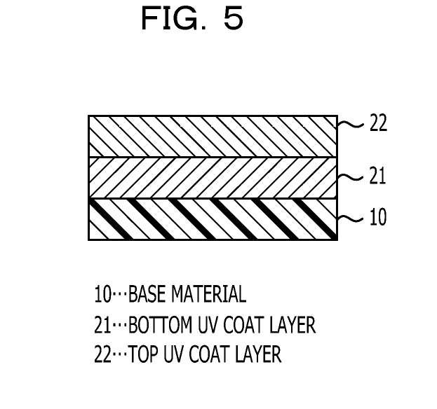

FIG. 5 illustrates an exemplary exterior coating. FIG. 5 is a fragmentary sectional view of the exterior coating. No underlying layer is formed over the base material 10. a bottom UV coat layer 21 is formed over the base material 10 and a top UV coat layer 22 is formed over the bottom UV coat layer 21. The bottom UV coat layer 21 has a lower hardness than the top UV coat layer 22. For example, in the case where the hardness of the bottom UV coat layer 21 is a pencil hardness of H, the hardness of the top UV coat layer 22 is set to a pencil hardness of 2H. The bottom UV coat layer 21 and the top UV coat layer 22 may have a thickness of 15 μm.

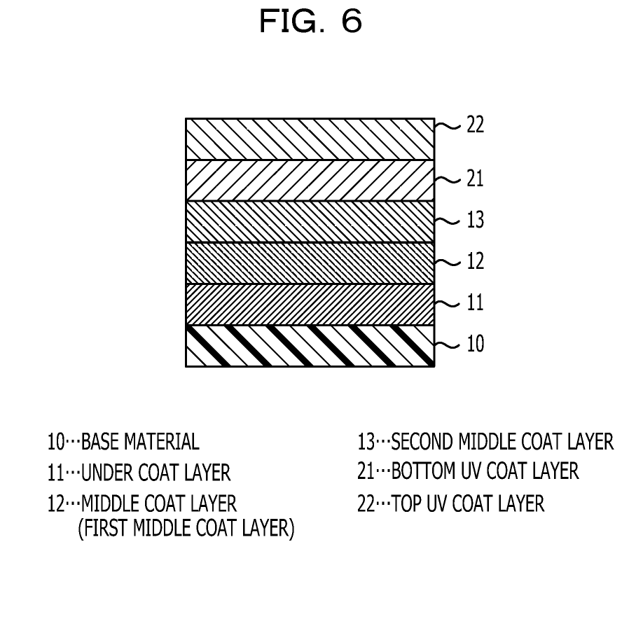

FIG. 6 illustrates an exemplary exterior coating. FIG. 6 is a fragmentary sectional view of the exterior coating. An undercoat layer 11 is formed over a base material 10 as an underlying layer and a first middle coat layer 12 and a second middle coat layer 13 are formed over the undercoat layer 11 as the underlying layer. A bottom UV coat layer 21 is formed over the second middle coat layer 13 and a top UV coat layer 22 is formed over the bottom UV coat layer 21. The bottom UV coat layer 21 has a lower hardness than the top UV coat layer 22. For example, in the case where the hardness of the bottom UV coat layer 21 is a pencil hardness of H, the hardness of the top UV coat layer 22 is set to a pencil hardness of 2H. The bottom UV coat layer 21 and the top UV coat layer 22 may have a thickness of 15 μm.

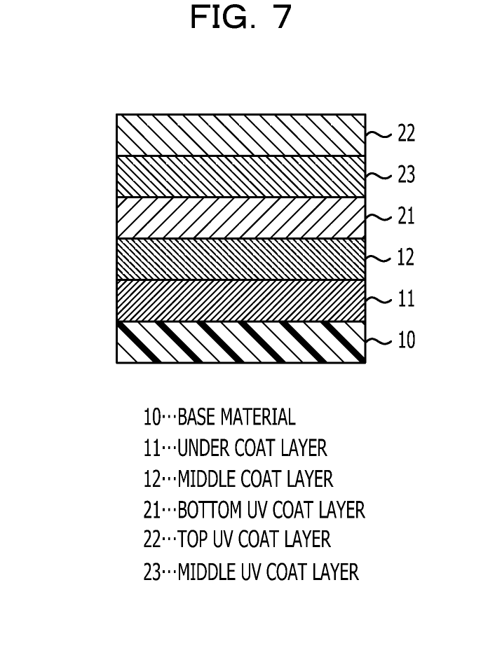

FIG. 7 illustrates an exemplary exterior coating. FIG. 7 is a fragmentary sectional view of the exterior coating. An undercoat layer 11 is formed over the base material 10 as an underlying layer and a middle coat layer 12 is formed over the undercoat layer 11 as the underlying layer. A bottom UV coat layer 21 is formed over the middle coat layer 12 and a middle UV coat layer 23 is formed over the bottom UV coat layer 21. A top UV coat layer 22 is formed over the middle UV coat layer 23. A hard coat layer includes three layers, for example, the bottom UV coat layer 21, the middle UV coat layer 23, and the top UV coat layer 22.

In the case where the hard coat layer includes the three layers, the top UV coat layer 22 may have the highest hardness, the bottom UV coat layer 21 may have the lowest hardness, and the middle UV coat layer 23 may have an intermediate hardness therebetween. For example, the hardness of the top UV coat layer 22 may be a pencil hardness of 2H, the hardness of the bottom UV coat layer 21 may be a pencil hardness of H, and the hardness of the middle UV coat layer 23 may be an intermediate hardness therebetween.

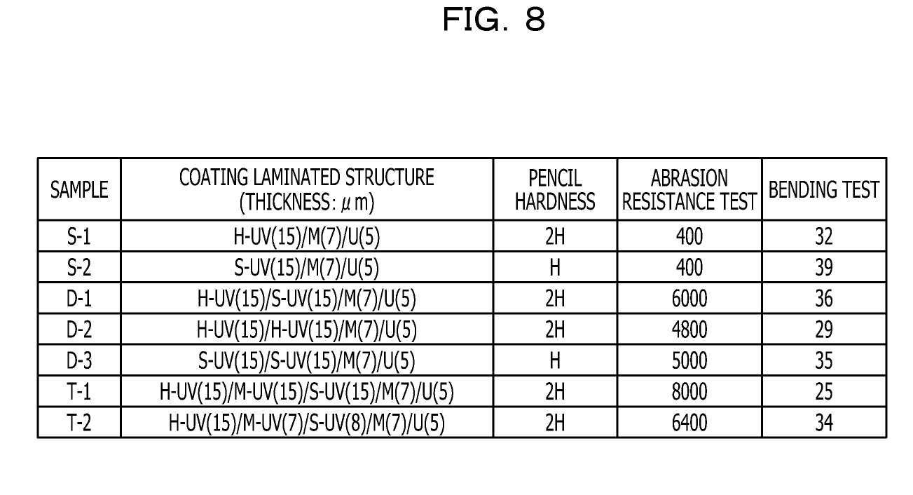

FIG. 8 illustrates an exemplary sample. FIG. 8 illustrates the laminated structures of coatings of the samples, which includes the thickness of layers, the pencil hardness, and the results of an abrasion resistance test and a bending test on each sample when two samples T-1 and T-2 each including a hard coat layer composed of three layers are added to the samples S-1, S-2, D-1, D-2, and D-3 illustrated in FIG. 2B and. The undercoat layer 11 of each of the samples S-1, S-2, D-1, D-2, D-3, T-1, and T-2 may have a thickness of 5 μm and the middle coat layer 12 thereof may have a thickness of 7 μm. In FIG. 8, the top UV coat layer 22 having the highest hardness is represented as H-UV, the middle UV coat layer 23 having an intermediate hardness is represented as M-UV, and the bottom UV coat layer 21 having the lowest hardness is represented as S-UV.

Each thickness is represented by numerals in parentheses in the coating laminated structure sections in FIG. 8. For example, “(15)” represents a thickness of 15 μm. Each of the bottom UV coat layer 21, the middle UV coat layer 23, and the top UV coat layer 22 of the sample T-1 may have a thickness of 15 μm. The bottom UV coat layer 21 of the sample T-2 may have a thickness of 8 μm, the middle UV coat layer 23 thereof may have a thickness of 7 μm, and the top UV coat layer 22 thereof may have a thickness of 15 μm. As illustrated in FIG. 8, as the total thickness of the bottom UV coat layer 21, the middle UV coat layer 23, and the top UV coat layer 22 is greater, the result of the abrasion resistance test may be better. Although the abrasion resistance of the sample T-2 is less than that of the sample T-1, the bending strength of the sample T-2 is greater than that of the sample T-1. Controlling the thickness of each UV coat layer controls the abrasion resistance and the bending strength.

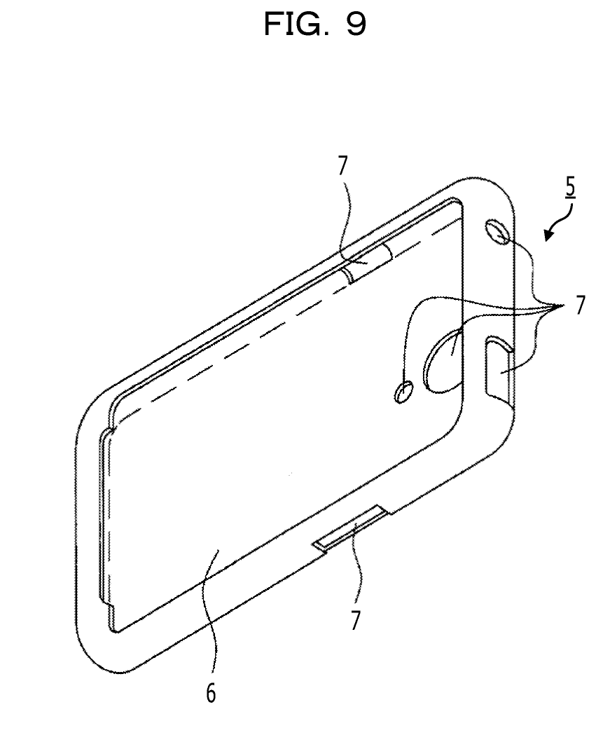

The above-described exterior coating may be applied to an exterior for a smartphone (multifunction mobile phone), a feature phone, a tablet computer, a notebook-sized computer, a personal digital assistant (PDA), a portable router, or an accessory. FIG. 9 illustrates an exemplary accessory. FIG. 9 is a perspective view of a mobile phone casing 5 to be fitted into the peripheral of the mobile phone 1 illustrated in FIG. 1A. The casing 5 includes an opening 6 in which the display 2 and the operation buttons 3 are exposed and a plurality of holes 7 in each of which functional part of the mobile phone 1 is exposed. The exterior coating may be applied to coating for a housing of an electronic device and an exterior for another object.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An exterior for an object, the exterior comprising:
a base portion;
an underlying layer disposed over the base portion; and
a hard coat layer disposed over the underlying layer, the hard coat layer including a plurality of layers that have different hardnesses and are laminated each other.

2. The exterior according to claim 1,
wherein the underlying layer includes an undercoat layer disposed over the base portion and a middle coat layer disposed over the undercoat layer, and
wherein the hard coat layer includes a first ultraviolet-curable hard coat layer disposed over the middle coat layer and a second ultraviolet-curable hard coat layer disposed over the first ultraviolet-curable hard coat layer.

3. The exterior according to claim 2, wherein the first ultraviolet-curable hard coat layer has a lower hardness than the second ultraviolet-curable hard coat layer.

4. The exterior according to claim 1,
wherein the underlying layer includes a middle coat layer disposed on the base portion, and
wherein the hard coat layer includes a first ultraviolet-curable hard coat layer disposed over the middle coat layer and a second ultraviolet-curable hard coat layer disposed over the first ultraviolet-curable hard coat layer.

5. The exterior according to claim 4, wherein the first ultraviolet-curable hard coat layer has a lower hardness than the second ultraviolet-curable hard coat layer.

6. The exterior according to claim 1,
wherein the underlying layer includes an undercoat layer disposed over the base portion, a first middle coat layer disposed over the undercoat layer, and a second middle coat layer disposed over the first middle coat layer, and
wherein the hard coat layer includes a first ultraviolet-curable hard coat layer disposed over the second middle coat layer and a second ultraviolet-curable hard coat layer disposed over the first ultraviolet-curable hard coat layer.

7. The exterior according to claim 6, wherein the first ultraviolet-curable hard coat layer has a lower hardness than the second ultraviolet-curable hard coat layer.

8. The exterior according to claim 1,
wherein the underlying layer includes an undercoat layer disposed over the base portion and a middle coat layer disposed over the undercoat layer, and
wherein the hard coat layer includes a first ultraviolet-curable hard coat layer disposed over the middle coat layer, a second ultraviolet-curable hard coat layer disposed over the first ultraviolet-curable hard coat layer, and a third ultraviolet-curable hard coat layer disposed over the second ultraviolet-curable hard coat layer.

9. The exterior according to claim 8, wherein the first ultraviolet-curable hard coat layer has a lower hardness than the second ultraviolet-curable hard coat layer and the second ultraviolet-curable hard coat layer has a lower hardness than the third ultraviolet-curable hard coat layer.

10. An exterior for an object, the exterior comprising:
a base portion; and
a hard coat layer disposed over the base portion, the hard coat layer including a first ultraviolet-curable hard coat layer disposed over the base portion and a second ultraviolet-curable hard coat layer disposed over the first ultraviolet-curable hard coat layer,
wherein the first ultraviolet-curable hard coat layer has a lower hardness than the second ultraviolet-curable hard coat layer.

11. An object with an exterior coating, the exterior coating comprising:
an underlying layer disposed over a base portion of an exterior of the object; and
a hard coat layer disposed over the underlying layer, the hard coat layer including a plurality of layers that have different hardnesses and are laminated each other.

12. The object with the exterior coating according to claim 11,
wherein the underlying layer includes an undercoat layer disposed over the base portion and a middle coat layer disposed over the undercoat layer, and
wherein the hard coat layer includes a first ultraviolet-curable hard coat layer disposed over the middle coat layer and a second ultraviolet-curable hard coat layer disposed over the first ultraviolet-curable hard coat layer.

13. The object with the exterior coating according to claim 12, wherein the first ultraviolet-curable hard coat layer has a lower hardness than the second ultraviolet-curable hard coat layer.

14. The object with the exterior coating according to claim 11, wherein the underlying layer includes a middle coat layer disposed over the base portion, and
wherein the hard coat layer includes a first ultraviolet-curable hard coat layer disposed over the middle coat layer and a second ultraviolet-curable hard coat layer disposed over the first ultraviolet-curable hard coat layer.

15. The object with the exterior coating according to claim 14, wherein the first ultraviolet-curable hard coat layer has a lower hardness than the second ultraviolet-curable hard coat layer.
